(19) United States
(12) Patent Application Publication
(10) Pub. No.: US 2006/0094485 A1
(43) Pub. Date: May 4, 2006

(54) Method and apparatus for preventing communication link degradation due to the detrimental orientation of a mobile station

(75) Inventor: Steven Jeffrey Goldberg, Downingtown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/014,585

(22) Filed: Dec. 16, 2004

Related U.S. Application Data
(60) Provisional application No. 60/622,888, filed on Oct. 28, 2004.

(51) Int. Cl. H04M 1/00

(52) U.S. Cl. 455/575.7

(57) ABSTRACT

A method and apparatus for preventing communication link degradation due to wireless transmit/receive unit (WTRU) position changes and detrimental orientation. When it is determined that at least one of a plurality of WTRUs in a communication link is moving or is going to move, the radio frequency (RF) beam pattern and/or link characteristics of a WTRU is adjusted to enhance communications. In another embodiment, the RF beam pattern and/or link characteristics are adjusted when it is determined that a gap in the communication link has occurred or will occur because one of the WTRUs has disengaged or is going to disengage from the communication link. In another embodiment, when a WTRU is in an undesired orientation, the WTRU instructs a user to physically move the WTRU. In another embodiment, information about the orientation of a WTRU is conveyed to a network that makes adjustments to enhance communications with the WTRU.

### CROSS REFERENCE TO RELATED APPLICATION

This application claims priority from U.S. provisional application No. 60/622,888, filed Oct. 28, 2004, which is incorporated by reference as if fully set forth.

### FIELD OF THE INVENTION

The present invention relates to the field of wireless communications. More particularly, the present invention relates to preventing the degradation of a communication link caused by a detrimental orientation of a wireless transmit/receive unit (WTRU), (e.g., a mobile station).

### BACKGROUND

In a conventional wireless communication system, beam forming is associated with radio frequency (RF) antenna arrays in the azimuth and elevation vernacular. This is suitable for fixed infrastructure deployments, or WTRUs, (e.g., cellular telephones, portable computers (PCs), or the like), with a preferred ad hoc deployment orientation.

Non-mobile ad hoc networks have radio resource functional units which try to sculpt antenna patterns in a system planning fashion. Tracking the movement of WTRUs and adjusting antenna patterns in a reactive fashion has been implemented by conventional wireless communication systems.

When the orientation of a WTRU's antenna with respect to the environment is known, the bore axis, power level, and beam width and depth, are each adjusted in a different fashion for optimum results.

However, the upcoming deployment of an adaptive type antenna on WTRUs cannot guarantee that the terms azimuth and elevation have any immediate relation to a WTRU's utilization of the antenna's adaptive capabilities. For example, WTRUs tossed into handbags and briefcases in a random fashion are still expected to communicate for transport of data, or call alerting to the user, although the device has no knowledge of its own relationship to the Earth. This lack of knowledge is carried over to the antenna system.

Furthermore, the quality of communications provided by a WTRU with a single antenna is diminished due to its poor orientation. Some WTRUs have two antennas, usually 90 degrees out of orientation with each other. For example, a whip antenna may be used for an expected WTRU orientation, and a wrapped core embedded antenna may be used for a less likely WTRU orientation.

Conventional wireless systems are disadvantageous because the WTRUs they service are built with an assumed orientation usage. The use of adaptive antenna methods will at best be suboptimal in usage. For example, the less likely WTRU orientation may cause half of the WTRU's antenna radiated power pattern focused into the ground instead of free air.

What is needed is a robust methodology for determining the orientation of WTRUs to mitigate degraded link conditions and minimize interference to other communication links in the vicinity.

### SUMMARY

The present invention is related to a method and apparatus for preventing communication link degradation due to the detrimental orientation of wireless transmit/receive units (WTRUs). In one embodiment, when a WTRU is in an undesired orientation, the WTRU instructs a user to physically move the WTRU. In another embodiment. the WTRU adjusts its beams based on its knowledge of the other communicating device's orientation. For example, if the WTRU assumes that the other device is stationary and its own movement is a rotation 45 degrees from its present orientation, the WTRU rotates its beam by that amount. If this is not within the resolution capability of the boresight adjustment, the WTRU determines the need to adjust its power level to provide adequate link margin.

In another embodiment, once the orientation of the WTRU is determined, information about the orientation is conveyed to an external entity, such as a particular RF network that services the WTRU. The control channel of the particular RF network is utilized to convey the appropriate control and status information. The RF network then makes the appropriate adjustments for transmitting and/or receiving based on the orientation information.

### BRIEF DESCRIPTION OF THE DRAWINGS

A more detailed understanding of the invention may be had from the following description, given by way of example and to be understood in conjunction with the accompanying drawings wherein:

FIGS. 1a and 1b show the nomenclature and coordinates used in accordance with the present invention;

FIG. 2a shows the nominal position of a WTRU in accordance with the present invention;

FIGS. 2b and 2c show other exemplary WTRU antenna orientations relative to the true ones in accordance with the present invention;

FIGS. 3a and 3b show different orientations of a sensor used to report to a WTRU the amount of force being exerted in three dimensions; and

FIG. 4 is an exemplary block diagram of a WTRU which operates in accordance with the present invention.

### DETAILED DESCRIPTION OF THE PREFERRED EMBODIMENT(S)

The preferred embodiments will be described with reference to the drawing figures where like numerals represent like elements throughout.

Hereafter, the terminology “WTRU” includes but is not limited to a user equipment (UE), a mobile station, a fixed or mobile subscriber unit, a pager, a transceiver, a portable computer (PC), a cellular telephone, or any other type of device capable of operating in a wireless environment.

The features of the present invention may be incorporated into an integrated circuit (IC) or be configured in a circuit comprising a multitude of interconnecting components.

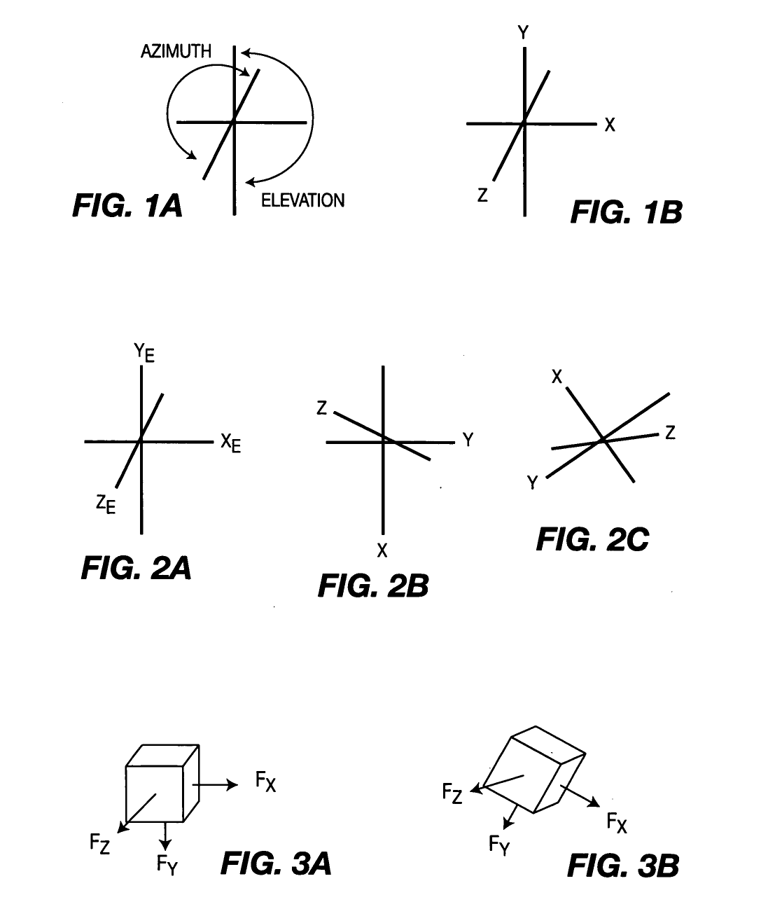

FIGS. 1a and 1b show the nomenclature and coordinates that will be used in accordance with the present invention. As shown, azimuth is an orientation relative to a plane parallel to the Earth, and elevation is an orientation perpendicular to the Earth. A point in space can be referenced by the X, Y, and Z coordinates as shown.

FIG. 2a shows a nominal position the prior art assumes for the WTRU's antenna, with the subscript “E” meaning the true coordinates.

FIGS. 2b and 2c show examples of the WTRU's possible inherent coordinates relative to the true ones in accordance with the present invention. For the prior art to work it must be assumed that the transceivers in each device use an omni directional antenna. This is a problem from several standpoints. It means all devices are transmitting in a fashion that will interfere with other devices, and receive signals from devices in all directions. Interference is therefore maximized. Power transmission in all directions also requires an excessive battery drain on each device.

The present invention enables WTRUs to orientate transmit and receive beams toward intended neighboring units. Signals are then transmitted only in the general direction of intended receivers, causing less interference to other WTRUs. Likewise, receivers receive signals only from the general direction of the transmitters, thus lessening the signals that will be received as interference. Since the transmitters are not sending signals in all directions, the same gain factor towards the intended receiver is achieved with an overall lower power drain on the device.

In one embodiment, internal orientation detection is used to determine the WTRU's true orientation to the Earth coordinate system, and adjust the pattern forming of the WTRU's antenna system to obtain the desired pattern relative to the Earth coordinates. In order for the beams to be oriented in the proper direction, the WTRU needs to know its orientation to Earth. By receiving signals from devices such as those illustrated in FIGS. 3a and 3b, the WTRU can determine its true orientation, such as those shown in FIGS. 1b and 1c. The WTRU can therefore orient its beams in any desired direction, which will usually be parallel to the Earth, as opposed, for example, to pointing the beam towards a surface above or below a desired target receiver.

A physical tracking device may be used to determine the orientation of the WTRU. Examples of physical tracking devices include fluid detectors, pendulums, gyroscopes and weight sensors. All of these physical tracking devices may be created in the form of micro-electro-mechanical systems (MEMS) for low cost and insignificant size requirements. For example, FIGS. 3a and 3b show different orientations of a sensor used to report to a WTRU the amount of force being exerting in three dimensions.

The physical tracking device is used to track a WTRU while communications are underway after any one of the other above-mentioned methods is used to determine the initial orientation of the WTRU. The physical gyroscope method can also be used by the user issuing an orientation command telling the device when it is in a specific orientation. While an object, such as a WTRU, may change its orientation, an unencumbered gyroscope therein will maintain a constant orientation to the gravitational field of the Earth. By sensing the gyroscope's orientation to the containing device, (i.e., the WTRU), the true ground reference vector necessary for determining three-dimensional axis rotational equations can be determined.

Once the deviation from the true Earth orientation is known, the correction factor can be calculated for the bore axis. The appropriate equations are dependant on the information available from the orientation determination method or methods available.

The following are general three dimensional axis rotational equations that can be adapted for this application.

True ground referenced vector is defined as follows:
(a,b,c)=R[x,y,z] Equation (1)
where the Euler angles (α,β,γ) are defined as follows: α is the rotation around the x-axis, β is the rotation around the y-axis, and γ is the rotation around the x-axis.

$$\begin{matrix}R = [ \begin{matrix}cos ( α ) cos ( β ) cos ( γ ) - sin ( α ) sin ( γ ) & - sin ( α ) cos ( β ) cos ( γ ) - cos ( α ) sin ( γ ) & sin ( β ) cos ( γ ) \\ sin ( α ) cos ( γ ) + cos ( α ) cos ( β ) sin ( γ ) & - sin ( α ) cos ( β ) sin ( γ ) + cos ( α ) cos ( γ ) & sin ( β ) sin ( γ ) \\ - cos ( α ) sin ( β ) & sin ( α ) sin ( β ) & cos ( β )\end{matrix} ] , \\ & Equation ( 2 ) \\ α = \frac{a}{\sqrt{{a}^{2} + {b}^{2} + {c}^{2}}} , & Equation ( 3 ) \\ β = \frac{b}{\sqrt{{a}^{2} + {b}^{2} + {c}^{2}}} , \\ and & Equation ( 4 ) \\ γ = \frac{c}{\sqrt{{a}^{2} + {b}^{2} + {c}^{2}}} . & Equation ( 5 )\end{matrix}$$

Determination of the Euler angles in accordance with Equations 3, 4 and 5 are used to rotate the exemplary arbitrary rotations of FIGS. 2b and 2c to the nominal orientation of 2a.

FIGS. 3a and 3b show a sensor that can report the force being exerting in three dimensions.

FIG. 3a shows the nominal position of the Y axis as being perpendicular to the ground, and the Y axis and Z axis as being parallel to the ground. In this ideal case, the values would be F_{Y}=F_{Max}, F_{X}=0, and F_{Z}=0.

FIG. 3b shows the sensor being rotated away from the nominal position of shown in FIG. 3a. The angles to adjust the coordinates of the sensor, and therefore of the device, (e.g., the WTRU), it is embedded into, is defined as follows:

$$\begin{matrix}α = - {cos}^{- 1} ( \frac{{F}_{Y}}{\sqrt{{F}_{X}^{2} + {F}_{Y}^{2} + {F}_{Z}^{2}}} ) , & Equation ( 6 ) \\ β = - {sin}^{- 1} ( \frac{{F}_{X}}{\sqrt{{F}_{X}^{2} + {F}_{Y}^{2} + {F}_{Z}^{2}}} ) , \\ and & Equation ( 7 ) \\ γ = - {sin}^{- 1} ( \frac{{F}_{Z}}{\sqrt{{F}_{X}^{2} + {F}_{Y}^{2} + {F}_{Z}^{2}}} ) . & Equation ( 8 )\end{matrix}$$

The three values being reported by a single sensor in FIGS. 3a and 3b could be also be provided by separate sensors mounted orthogonal to each other. Likewise, non-orthogonal sensors could be used, with the appropriate orientation angles taken into account when performing the calculations.

Another approach is to modify the sensor embedded within the WTRU, so that it is forced to rotate with the WTRU, but provide as means to detect any such forced rotation. U.S. Pat. No. 6,796,179 entitled “Split-Resonator Integrated-Post MEMS Gyroscope,” which was issued to Bae et al. on Sep. 28, 2004, discloses an example of a micro-sized device suitable for implementing the features of the sensor disclosed herein in accordance with the present invention.

In another embodiment, reflective probing may be implemented by sending a test transmission and examining the effects, or lack of them, based on voltage standing wave ratio (VSWR) measurements and receiver interceptions. When an RF signal is transmitted from an antenna, some of the energy may be reflected back into the antenna. This causes a VSWR value to deviate from an ideal ratio value of one. By transmitting test signals at various boresight orientations, and measuring the associated VSWR values, it can be determined where there are obstructions, as the VSWR measurement readings will appear as higher deviations from one. Furthermore, this technique may be used to determine which directions the WTRU can best send signals. In most applications, this will also be a good indication of the best receive directions. In the best case, reciprocity of the channel is applicable. In the case of physical blockage however, reciprocity is not a necessity to determine the best directional characteristics.

In yet another embodiment, signal orientation may be implemented by using signal searching techniques in all the WTRU's degrees of available freedom to determine the appropriate orientation for receive and transmission boresight directions. Once the information is determined, there are a number of possible uses for the determined orientation, as described below.

In one embodiment, the formation of the antenna beam pattern of the WTRU and other transmitter or receiver characteristics are adjusted as is appropriate to determine the orientation of true ground. The antenna beam pattern of the WTRU may be adjusted taking into account the limitations of the beam pattern control available in the WTRU or measured signal characteristics, such as VSWR, receiver interceptions, signal searching techniques, reflective probing and/or signal orientation.

The ability to adjust beam patterns will vary considerably from one implementation to another. Some devices, such as InterDigital's Trident antenna, have only left, right and omni beam patterns. Other implementations, especially those using phased array techniques, can finely adjust RF antenna pattern boresights in single degree resolutions. The control of the beam width of the WTRUs will also come into play, and may considerably vary depending upon the complexity of the design.

In another embodiment, the network is informed of a particular WTRU's orientation so that it may adjust its transmission and/or receivers appropriately. In this case, the particular WTRU informs the network of its best beam orientation. The network adjusts its beams and/or switches to another antenna with an improved likelihood of communicating with the device.

In another embodiment, the network is informed of a particular WTRU's orientation and transmits adjustment information to the WTRU such that its operation can be adjusted in accordance with the adjustment information. In this case, the particular WTRU may seek additional aid from the network. For example, the network may determine that the particular WTRU's orientation is more conducive to a signal from an approximately 180 degrees azimuth rotation to its present link. Thus, the WTRU may be instructed by the network to use beams changing the direction 180 degrees azimuth from its present settings.

While the present invention uses a three dimensional determination methodology, there may be other implementations where only two orthogonal dimensions are used. Some of the directions may best be served by force measuring devices, and other dimensions may be best served by angle or contact sensors.

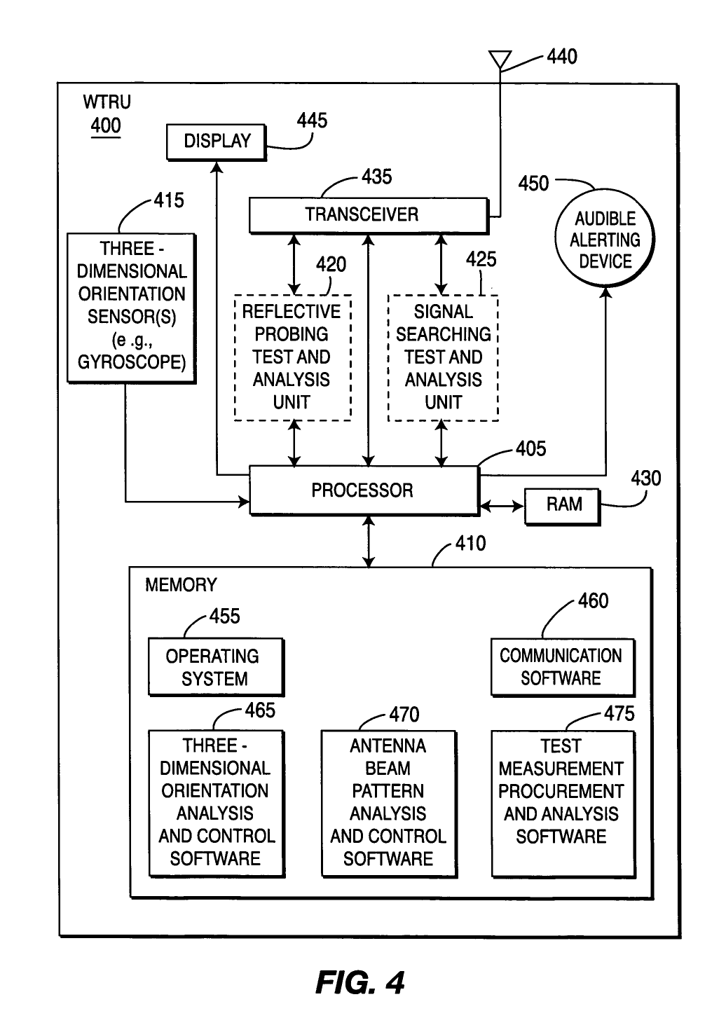

FIG. 4 shows a WTRU 400 intended to be operated by a user for communication with other WTRUs. The WTRU 400 includes a processor 405, a memory 410, at least one three-dimensional orientation sensor 415, an optional reflective probing test and analysis unit 420, an optional signal searching test and analysis unit 425, a random access memory (RAM) 430, a transceiver 435, a beam forming antenna 440, a display 445 and an audible alerting device 450.

The memory 410 includes an operating system 455, communication software 460, three-dimensional orientation analysis and control software 465, antenna beam pattern analysis and control software 470, and test measurement procurement and analysis software 475, which are used by the processor 405 in conjunction with the three-dimensional orientation sensor(s) 415, the optional reflective probing test and analysis unit 420, and the optional signal searching test and analysis unit 425.

The transceiver 435 is communicatively coupled to the processor 405 and the antenna 440. The processor 405 employs the communication software 460 to process communication data signals received and transmitted via the beam forming antenna 440.

The RAM 430 is communicatively coupled to the processor 405 and is generally used to maintain specific operational data including other WTRUs that the WTRU 400 communicates with, destination devices within communication range of the WTRU 400, communication link quality parameters relating to the quality of individual communication links with the other WTRUs, parameters relating to the location of the WTRU 400 relative to other WTRUs and directional data with reference to the other WTRUs.

The three-dimensional orientation sensor(s) 415 is communicatively coupled to the processor 405 and is generally used to determine the true orientation of the WTRU 400 to the Earth coordinate system. The three-dimensional orientation sensor(s) 415 may be a single physical tracking device, a plurality of separate sensors mounted orthogonal to each other, or a plurality of non-orthogonal sensors, as described above.

As shown in FIGS. 3a and 3b, different orientations of the WTRU 400 cause the three-dimensional orientation sensor(s) 415 in the WTRU 400 to report the amount of force being exerted in three dimensions, (i.e., F_{X}, F_{Y} and F_{Z}). The three-dimensional orientation analysis and control software 465 in the memory 410 operates in conjunction with the three-dimensional orientation sensor(s) 415 and the processor 405 to determine three-dimensional axis rotational equations, deviations from the true Earth orientation and correction factors, (i.e., Euler angles). The three-dimensional orientation analysis and control software 465 compares readings provided by the three-dimensional orientation sensor(s) 415 to an established nominal orientation, (e.g., true Earth orientation), to determine the deviation in orientation of the WTRU 400 from the nominal orientation.

The antenna beam pattern analysis and control software 470 and test measurement procurement and analysis software 475 may be used to control the transceiver 435 and the beam forming antenna 440 via the processor 405. Furthermore, the beam patterns formed by the antenna 440, and/or the transmission and receiver characteristics of the transceiver 435 and/or the beam forming antenna 440, may be adjusted based on the results of test measurements, (e.g., VSWR determined by reflective probing, boresight determined by signal searching, or the like), performed by the optional reflective probing test and analysis unit 420 or the optional signal searching test and analysis unit 420.

In one embodiment, the WTRU 400 alerts the user when the present orientation of the WTRU 400 is detrimental to its operation. This may occur when the three-dimensional orientation sensor(s) 415 indicates to the processor 405 that, given the present orientation of the WTRU 400 and its ability to change the form of beams transmitted from the antenna 440, there is nothing significant that the WTRU 400 can automatically do to improve its communication situation, and the user will therefore have to manually correct the situation. For example, if the three-dimensional orientation sensor(s) 415 detects that the orientation of the WTRU 400, (or the antenna 440 attached thereto, is 90 degrees away from vertical, (a condition which is possible when the WTRU 400 is laying on a surface), the processor 405 in the WTRU 400 provides text and/or an audible output, via the display 445 and/or the audible alerting device 450, instructing the user to physically move the WTRU 400 to a normal antenna orientation in the vertical plane. Alternatively, a vibrating device (not shown) mounted in the WTRU 400 may be used to alert the user of the WTRU 400.

While the present invention has been described in terms of the preferred embodiment, other variations which are within the scope of the invention as outlined in the claims below will be apparent to those skilled in the art.

What is claimed is:

1. A wireless transmit/receive unit (WTRU) comprising:
(a) a processor;
(b) a transceiver in communication with the processor;
(c) a beam forming antenna in communication with the transceiver;
(d) at least one physical tracking device in communication with the processor, the physical tracking device being configured to determine the WTRU's current orientation; and
(e) means for conveying the WTRU's current orientation to an external entity in communication with the WTRU, wherein the external entity makes adjustments based on the WTRU's current orientation to enhance communications with the WTRU.

2. The WTRU of claim 1 wherein the physical tracking device is a three-dimensional orientation sensor.

3. The WTRU of claim 1 wherein the physical tracking device is a gyroscope.

4. The WTRU of claim 1 wherein the physical tracking device comprises a plurality of separate sensors mounted orthogonal to each other within the WTRU.

5. The WTRU of claim 1 wherein the physical tracking device reports the force being exerted in three dimensions.

6. A wireless transmit/receive unit (WTRU) comprising:
(a) a processor;
(b) a transceiver in communication with the processor;
(c) a beam forming antenna in communication with the transceiver;
(d) means for performing reflective probing tests using the transceiver and antenna to transmit test signals at various boresight orientations and determining results of the tests; and
(e) means for adjusting the characteristics of the transceiver and at least one beam formed by the antenna based on the reflective probing test results.

7. The WTRU of claim 6 where the reflective probing tests compare voltage standing wave ratio (VSWR) measurement results to an ideal ratio value of one.

8. The WTRU of claim 6 wherein the reflective probing test results are used to determine the best directions for the WTRU to transmit and receive signals.

9. The WTRU of claim 6 wherein the characteristics of the transceiver and at least one beam formed by the antenna are adjusted as is appropriate to determine the orientation of true ground based on the probing test results.

10. The WTRU of claim 9 wherein the characteristics include the width of the at least one beam.

11. A wireless transmit/receive unit (WTRU) comprising:
(a) a processor;
(b) a transceiver in communication with the processor;
(c) a beam forming antenna in communication with the transceiver; and
(d) means for performing boresight signal searching tests using the transceiver and antenna to transmit test signals in all of the WTRU's degrees of available freedom to determine the appropriate orientation for receive and transmission boresight directions; and
(e) means for adjusting the characteristics of the transceiver and at least one beam formed by the antenna based on the boresight signal searching test results.

12. The WTRU of claim 11 wherein the characteristics of the transceiver and at least one beam formed by the antenna are adjusted as is appropriate to determine the orientation of true ground based on the boresight signal searching test results.

13. The WTRU of claim 12 wherein the characteristics include the width of the at least one beam.

14. In a wireless communication system including a network in communication with a plurality of wireless transmit/receive units (WTRUs), each WTRU comprising:
(a) a transceiver;
(b) a beam forming antenna in communication with the transceiver; and
(c) means for conveying information to the network, the information indicating the orientation of the WTRU and the WTRU's best beam orientation as formed by the antenna, wherein the network adjusts its communication characteristics to enhance communications with the WTRU.

15. In a wireless communication system including a network in communication with a plurality of wireless transmit/receive units (WTRUs), each WTRU comprising:
(a) a transceiver;
(b) a beam forming antenna in communication with the transceiver;
(c) means for conveying information to the network, the information indicating the orientation of the WTRU; and
(d) means for receiving adjustment information derived by the network based on the WTRU orientation information, the adjustment information being used by the WTRU to adjust at least one beam formed by the antenna.

16. A wireless transmit/receive unit (WTRU) comprising:
(a) a processor;
(b) a transceiver in communication with the processor;
(c) a beam forming antenna in communication with the transceiver;
(d) at least one three-dimensional orientation sensor in communication with the processor; and
(e) means for determining a deviation between the WTRU's current orientation, as indicated by the sensor, and an established nominal orientation, wherein a pattern of one or more beams formed by the antenna is adjusted to enhance the quality of communications based on the orientation of the WTRU.

17. A wireless transmit/receive unit (WTRU) comprising:
(a) a processor;
(b) at least one orientation sensor in communication with the processor; and
(c) an alerting device in communication with the processor, wherein the alerting device alerts a user of the WTRU to physically move the WTRU to a different orientation that improves the communication performance of the WTRU when the sensor indicates to the processor that the WTRU is in an undesirable orientation that degrades the communication performance of the WTRU.

18. The WTRU of claim 17 wherein the alerting device is a display.

19. The WTRU of claim 17 wherein the alerting device is an audible device.

20. The WTRU of claim 17 wherein the alerting device is a vibrating device.

21. In a wireless communication including a network in communication with at least one wireless transmit/receive unit (WTRU), the WTRU including at least one physical tracking device, a method comprising:
(a) determining the WTRU's current orientation based on information provided by the physical tracking device; and
(b) conveying the WTRU's current orientation to an external entity in communication with the WTRU, wherein the external entity makes adjustments based on the WTRU's current orientation to enhance communications with the WTRU.

22. The method of claim 21 wherein the physical tracking device is a three-dimensional orientation sensor.

23. The method of claim 21 wherein the physical tracking device is a gyroscope.

24. The method of claim 21 wherein the physical tracking device comprises a plurality of separate sensors mounted orthogonal to each other within the WTRU.

25. The method of claim 21 wherein the physical tracking device reports the force being exerted in three dimensions.

26. In a wireless communication including a network in communication with at least one wireless transmit/receive unit (WTRU), the WTRU including a transceiver in communication with a beamforming antenna, a method comprising:
(a) performing reflective probing tests using the transceiver and antenna to transmit test signals at various boresight orientations and determining results of the tests; and
(b) adjusting the characteristics of the transceiver and at least one beam formed by the antenna based on the reflective probing test results.

27. The method of claim 26 wherein the reflective probing tests compare voltage standing wave ratio (VSWR) measurement results to an ideal ratio value of one.

28. The method of claim 26 wherein the reflective probing test results are used to determine the best directions for the WTRU to transmit and receive signals.

29. The method of claim 26 wherein the characteristics of the transceiver and at least one beam formed by the antenna are adjusted as is appropriate to determine the orientation of true ground based on the probing test results.

30. The method of claim 29 wherein the characteristics include the width of the at least one beam.

31. In a wireless communication including a network in communication with at least one wireless transmit/receive unit (WTRU), the WTRU including at least one physical tracking device, a method comprising:
(a) sensing that the WTRU is in an undesirable orientation that degrades the communication performance of the WTRU; and
(b) alerting a user of the WTRU to physically move the WTRU to a different orientation that improves the communication performance of the WTRU.
